(19) United States
(12) Patent Application Publication
(10) Pub. No.: US 2014/0070625 A1
(43) Pub. Date: Mar. 13, 2014

(54) METHOD FOR COMMUNICATION AND POWER CONTROL OF WIRELESS POWER TRANSMITTER IN MAGNETIC RESONANT WIRELESS POWER TRANSMISSION SYSTEM

(71) Applicant: SAMSUNG ELECTRONICS CO., LTD., Suwon-si (KR)

(72) Inventors: Nam Yun KIM, Seoul (KR); Sang Wook KWON, Seongnam-si (KR); Yun Kwon PARK, Dongducheon-si (KR)

(73) Assignee: SAMSUNG ELECTRONICS CO., LTD., Suwon-si (KR)

(21) Appl. No.: 14/020,507

(22) Filed: Sep. 6, 2013

(30) Foreign Application Priority Data
Sep. 7, 2012 (KR) 10-2012-0099113

(51) Int. Cl. H01F 38/14

(52) U.S. Cl. CPC H01F 38/14
USPC 307/104

(57) ABSTRACT

A method for communication and power control of a wireless power transmitter, includes transmitting notice information to a wireless power receiver, and detecting a wireless power receiver based on the notice information, the wireless power receiver accessing the wireless power transmitter. The method further includes determining whether the wireless power receiver is to cease the accessing of the wireless power transmitter based on a power control and/or a power transmission efficiency, and transmitting a reset command to the wireless power receiver in response to the wireless power receiver being determined to incorrectly access the wireless power transmitter.

### CROSS-REFERENCE TO RELATED APPLICATION(S)

This application claims the benefit under 35 USC 119(a) of Korean Patent Application No. 10-2012-0099113, filed on Sep. 7, 2012, in the Korean Intellectual Property Office, the entire disclosure of which is incorporated herein by reference for all purposes.

### BACKGROUND

1. Field

The following description relates to a method for communication and power control of a wireless power transmitter in a magnetic resonant wireless power transmission system.

2. Description of Related Art

Wireless power refers to energy transferred from a wireless power transmitter to a wireless power receiver through magnetic coupling. Accordingly, a wireless power transmission system, or a wireless power charging system, includes a source device configured to wirelessly transmit power, and a target device configured to wirelessly receive power. The source device may be referred to as a source or a wireless power transmitter, and the target device may be referred to as a target or a wireless power receiver.

The source device includes a source resonator, and the target device includes a target resonator. Magnetic resonant coupling may be formed between the source resonator and the target resonator.

### SUMMARY

In one general aspect, there is provided a method for communication and power control of a wireless power transmitter in a magnetic resonant wireless power transmission system, the method including transmitting notice information to a wireless power receiver, and detecting a wireless power receiver based on the notice information, the wireless power receiver accessing the wireless power transmitter. The method further includes determining whether the wireless power receiver is to cease the accessing of the wireless power transmitter based on a power control and/or a power transmission efficiency, and transmitting a reset command to the wireless power receiver in response to the wireless power receiver being determined to incorrectly access the wireless power transmitter.

In another general aspect, there is provided a method for communication and power control of a wireless power receiver in a magnetic resonant wireless power transmission system, the method including receiving notice information from a wireless power transmitter, and transmitting a search signal to the wireless power transmitter based on the notice information. The method further includes accessing the wireless power transmitter based on the search signal, and resetting the wireless power receiver in response to a reset command being received from the wireless power transmitter.

In still another general aspect, there is provided a magnetic resonant wireless power transmitter including a communication unit configured to transmit notice information to a wireless power receiver. The transmitter further includes a controller configured to detect the wireless power receiver based on the notice information, the wireless power receiver accessing the wireless power transmitter, and determine whether the wireless power receiver is to cease the accessing of the wireless power transmitter based on a power control and/or a power transmission efficiency. The communication unit is further configured to transmit a reset command to the wireless power receiver in response to the wireless power receiver being determined to incorrectly access the wireless power transmitter.

In yet another general aspect, there is provided a magnetic resonant wireless power receiver including a communication unit configured to receive notice information from a wireless power transmitter, and transmit a search signal to the wireless power transmitter based on the notice information. The receiver further includes a controller configured to access the wireless power transmitter based on the search signal, and reset the wireless power receiver in response to a reset command being received from the wireless power transmitter.

Other features and aspects will be apparent from the following detailed description, the drawings, and the claims.

### BRIEF DESCRIPTION OF THE DRAWINGS

FIG. 1 is a diagram illustrating an example of a wireless power transmission system.

FIGS. 2A and 2B are diagrams illustrating examples of a distribution of a magnetic field in a feeder and a resonator of a wireless power transmitter.

FIGS. 3A and 3B are diagrams illustrating an example of a feeding unit and a resonator of a wireless power transmitter.

FIG. 4A is a diagram illustrating an example of a distribution of a magnetic field in a resonator that is produced by feeding of a feeding unit, of a wireless power transmitter.

FIG. 4B is a diagram illustrating examples of equivalent circuits of a feeding unit and a resonator of a wireless power transmitter.

FIG. 5 is a diagram illustrating an example of an electric vehicle charging system.

FIGS. 6A through 7B are diagrams illustrating examples of applications in which a wireless power receiver and a wireless power transmitter are mounted.

FIG. 8 is a diagram illustrating another example of a wireless power transmission system.

FIG. 9 is a diagram illustrating an example of a multi-source environment.

FIG. 10 is a diagram illustrating an example of a method of controlling power in a wireless power transmitter.

FIG. 11 is a flowchart illustrating an example of a method of performing communication and controlling power in a magnetic resonant wireless power transmission system.

FIG. 12 is a flowchart illustrating an example of a method of detecting a device in a magnetic resonant wireless power transmission system.

FIG. 13 is a flowchart illustrating an example of a method of controlling power in a magnetic resonant wireless power transmission system.

FIG. 14 is a diagram illustrating an example of a wireless power transmitter.

FIG. 15 is a diagram illustrating an example of a wireless power receiver.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. Also, descriptions of functions and constructions that are well known to one of ordinary skill in the art may be omitted for increased clarity and conciseness.

Throughout the drawings and the detailed description, the same reference numerals refer to the same elements. The drawings may not be to scale, and the relative size, proportions, and depiction of elements in the drawings may be exaggerated for clarity, illustration, and convenience.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

A scheme of performing communication between a source device and a target device may include an in-band communication scheme and an out-band communication scheme. In the in-band communication scheme, the source device and the target device may communicate with each other, using the same frequency as used for power transmission. In the out-band communication scheme, the source device and the target device may communicate with each other, using different frequencies from those used for the power transmission.

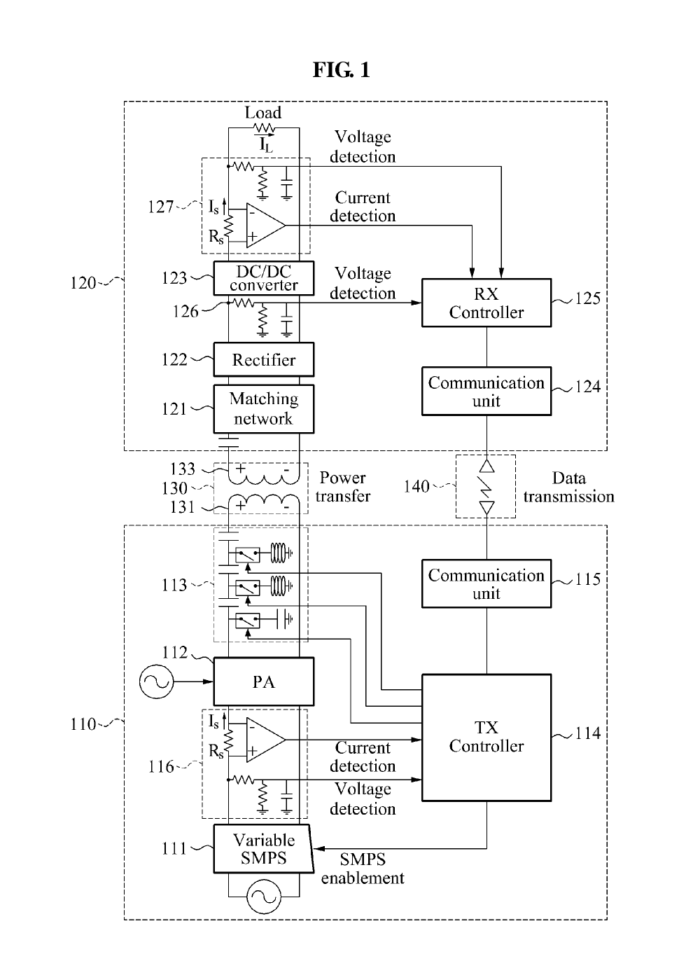

FIG. 1 is a diagram illustrating an example of a wireless power transmission system. Referring to FIG. 1, the wireless power transmission system includes a source device 110 and a target device 120. The source device 110 is a device supplying wireless power, and may be any of various devices that supply power, such as pads, terminals, televisions (TVs), and any other device that supplies power. The target device 120 is a device receiving wireless power, and may be any of various devices that consume power, such as terminals, TVs, vehicles, washing machines, radios, lighting systems, and any other device that consumes power.

The source device 110 includes a variable switching mode power supply (SMPS) 111, a power amplifier 112, a matching network 113, a transmission (TX) controller 114 (e.g., a TX control logic), a communication unit 115, a power detector 116, and a source resonator 131. The target device 120 includes a matching network 121, a rectifier 122, a direct current-to-direct current (DC/DC) converter 123, a communication unit 124, a reception (RX) controller 125 (e.g., a RX control logic), a power detector 127, and a target resonator 133.

The variable SMPS 111 generates a DC voltage by switching an alternating current (AC) voltage having a frequency of tens of hertz (Hz) output from a power supply. The variable SMPS 111 may output a DC voltage having a predetermined level, or may output a DC voltage having an adjustable level by the controller 114.

The power detector 116 detects an output current and an output voltage of the variable SMPS 111, and provides, to the controller 114, information on the detected current and the detected voltage. Additionally, the power detector 116 detects an input current and an input voltage of the power amplifier 112.

The power amplifier 112 generates a power by converting the DC voltage output from the variable SMPS 111 to an AC voltage using a switching pulse signal having a frequency of a few kilohertz (kHz) to tens of megahertz (MHz). In other words, the power amplifier 112 converts a DC voltage supplied to a power amplifier to an AC voltage using a reference resonance frequency F_{Ref}, and generates a communication power to be used for communication, or a charging power to be used for charging that may be used in a plurality of target devices. The communication power may be, for example, a low power of 0.1 to 1 milliwatts (mW) that may be used by a target device to perform communication, and the charging power may be, for example, a high power of 1 mW to 200 Watts (W) that may be consumed by a device load of a target device. In this description, the term “charging” may refer to supplying power to an element or a unit that charges a battery or other rechargeable device with power. Also, the term “charging” may refer supplying power to an element or a unit that consumes power. For example, the term “charging power” may refer to power consumed by a target device while operating, or power used to charge a battery of the target device. The unit or the element may include, for example, a battery, a display device, a sound output circuit, a main processor, and various types of sensors.

In this description, the term “reference resonance frequency” refers to a resonance frequency that is nominally used by the source device 110, and the term “tracking frequency” refers to a resonance frequency used by the source device 110 that has been adjusted based on a predetermined scheme.

The controller 114 may detect a reflected wave of the communication power or a reflected wave of the charging power, and may detect mismatching between the target resonator 133 and the source resonator 131 based on the detected reflected wave. The controller 114 may detect the mismatching by detecting an envelope of the reflected wave, or by detecting an amount of a power of the reflected wave.

Under the control of the controller 114, the matching network 113 compensates for impedance mismatching between the source resonator 131 and the target resonator 133 so that the source resonator 131 and the target resonator 133 are optimally-matched. The matching network 113 includes combinations of a capacitor and an inductor that are connected to the controller 114 through a switch, which is under the control of the controller 114.

The controller 114 may calculate a voltage standing wave ratio (VSWR) based on a voltage level of the reflected wave and a level of an output voltage of the source resonator 131 or the power amplifier 112. When the VSWR is greater than a predetermined value, the controller 114 detects the mismatching. In this example, the controller 114 calculates a power transmission efficiency of each of N predetermined tracking frequencies, determines a tracking frequency F_{Best} having the best power transmission efficiency among the N predetermined tracking frequencies, and changes the reference resonance frequency F_{Ref} to the tracking frequency F_{Best}.

Also, the controller 114 may control a frequency of the switching pulse signal used by the power amplifier 112. By controlling the switching pulse signal used by the power amplifier 112, the controller 114 may generate a modulation signal to be transmitted to the target device 120. In other words, the communication unit 115 may transmit various messages to the target device 120 via in-band communication. Additionally, the controller 114 may detect a reflected wave, and may demodulate a signal received from the target device 120 through an envelope of the reflected wave.

The controller 114 may generate a modulation signal for in-band communication using various schemes. To generate a modulation signal, the controller 114 may turn on or off the switching pulse signal used by the power amplifier 112, or may perform delta-sigma modulation. Additionally, the controller 114 may generate a pulse-width modulation (PWM) signal having a predetermined envelope.

The communication unit 115 may perform out-of-band communication using a communication channel. The communication unit 115 may include a communication module, such as a ZigBee module, a Bluetooth module, or any other communication module, that the communication unit 115 may use to perform the out-of-band communication. The communication unit 115 may transmit or receive data 140 to or from the target device 120 via the out-of-band communication.

The source resonator 131 transfers electromagnetic energy 130, such as the communication power or the charging power, to the target resonator 133 via a magnetic coupling with the target resonator 133.

The target resonator 133 receives the electromagnetic energy 130, such as the communication power or the charging power, from the source resonator 131 via a magnetic coupling with the source resonator 131. Additionally, the target resonator 133 receives various messages from the source device 110 via the in-band communication.

The matching network 121 matches an input impedance viewed from the source device 110 to an output impedance viewed from a load. The matching network 121 may be configured with a combination of a capacitor and an inductor.

The rectifier 122 generates a DC voltage by rectifying an AC voltage received by the target resonator 133.

The DC/DC converter 123 adjusts a level of the DC voltage output from the rectifier 122 based on a voltage rating of the load. For example, the DC/DC converter 123 may adjust the level of the DC voltage output from the rectifier 122 to a level in a range from 3 volts (V) to 10 V.

The power detector 127 detects a voltage (e.g., V_{dd}) of an input terminal 126 of the DC/DC converter 123, and a current and a voltage of an output terminal of the DC/DC converter 123. The power detector 127 outputs the detected voltage of the input terminal 126, and the detected current and the detected voltage of the output terminal, to the controller 125. The controller 125 uses the detected voltage of the input terminal 126 to compute a transmission efficiency of power received from the source device 110. Additionally, the controller 125 uses the detected current and the detected voltage of the output terminal to compute an amount of power transferred to the load. The controller 114 of the source device 110 determines an amount of power that needs to be transmitted by the source device 110 based on an amount of power required by the load and the amount of power transferred to the load. When the communication unit 124 transfers an amount of power of the output terminal (e.g., the computed amount of power transferred to the load) to the source device 110, the controller 114 of the source device 110 may compute the amount of power that needs to be transmitted by the source device 110.

The communication unit 124 may perform in-band communication for transmitting or receiving data using a resonance frequency by demodulating a received signal obtained by detecting a signal between the target resonator 133 and the rectifier 122, or by detecting an output signal of the rectifier 122. In other words, the controller 125 may demodulate a message received via the in-band communication.

Additionally, the controller 125 may adjust an impedance of the target resonator 133 to modulate a signal to be transmitted to the source device 110. For example, the controller 125 may increase the impedance of the target resonator so that a reflected wave will be detected by the controller 114 of the source device 110. In this example, depending on whether the reflected wave is detected, the controller 114 of the source device 110 will detect a binary number “0” or “1”.

The communication unit 124 may transmit, to the source device 110, any one or any combination of a response message including a product type of a corresponding target device, manufacturer information of the corresponding target device, a product model name of the corresponding target device, a battery type of the corresponding target device, a charging scheme of the corresponding target device, an impedance value of a load of the corresponding target device, information about a characteristic of a target resonator of the corresponding target device, information about a frequency band used the corresponding target device, an amount of power to be used by the corresponding target device, an intrinsic identifier of the corresponding target device, product version information of the corresponding target device, and standards information of the corresponding target device.

The communication unit 124 may also perform an out-of-band communication using a communication channel. The communication unit 124 may include a communication module, such as a ZigBee module, a Bluetooth module, or any other communication module known in the art, that the communication unit 124 may use to transmit or receive data 140 to or from the source device 110 via the out-of-band communication.

The communication unit 124 may receive a wake-up request message from the source device 110, detect an amount of a power received by the target resonator, and transmit, to the source device 110, information about the amount of the power received by the target resonator. In this example, the information about the amount of the power received by the target resonator may correspond to an input voltage value and an input current value of the rectifier 122, an output voltage value and an output current value of the rectifier 122, or an output voltage value and an output current value of the DC/DC converter 123.

The TX controller 114 sets a resonance bandwidth of the source resonator 131. Based on the resonance bandwidth of the source resonator 131, a Q-factor of the source resonator 131 is set.

The RX controller 125 sets a resonance bandwidth of the target resonator 133. Based on the resonance bandwidth of the target resonator 133, a Q-factor of the target resonator 133 is set. For example, the resonance bandwidth of the source resonator 131 may be set to be wider or narrower than the resonance bandwidth of the target resonator 133.

The source device 110 and the target device 120 communicate with each other to share information about the resonance bandwidth of the source resonator 131 and the resonance bandwidth of the target resonator 133. If power desired or needed by the target device 120 is greater than a reference value, the Q-factor of the source resonator 131 may be set to be greater than 100. If the power desired or needed by the target device 120 is less than the reference value, the Q-factor of the source resonator 131 may be set to less than 100.

The source device 110 wirelessly transmits wake-up power used to wake up the target device 120, and broadcasts a configuration signal used to configure a wireless power transmission network. The source device 110 further receives, from the target device 120, a search frame including a receiving sensitivity of the configuration signal, and may further permit a join of the target device 120. The source device 110 may further transmit, to the target device 120, an ID used to identify the target device 120 in the wireless power transmission network. The source device 110 may further generate the charging power through a power control, and may further wirelessly transmit the charging power to the target device 120.

The target device 120 receives wake-up power from at least one of source devices, and activates a communication function, using the wake-up power. The target device 120 further receives, from at least one of the source devices, a configuration signal used to configure a wireless power transmission network, and may further select the source device 110 based on a receiving sensitivity of the configuration signal. The target device 120 may further wirelessly receive power from the selected source device 110.

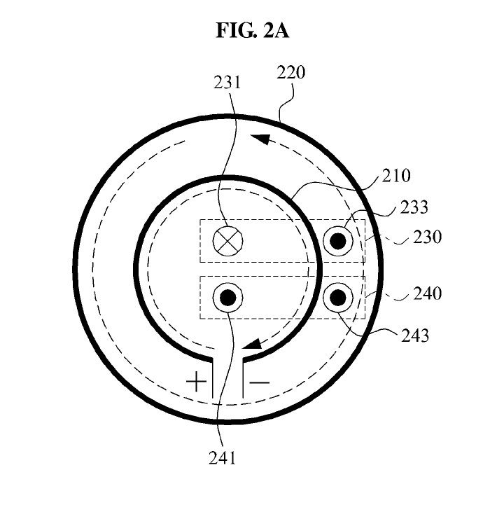

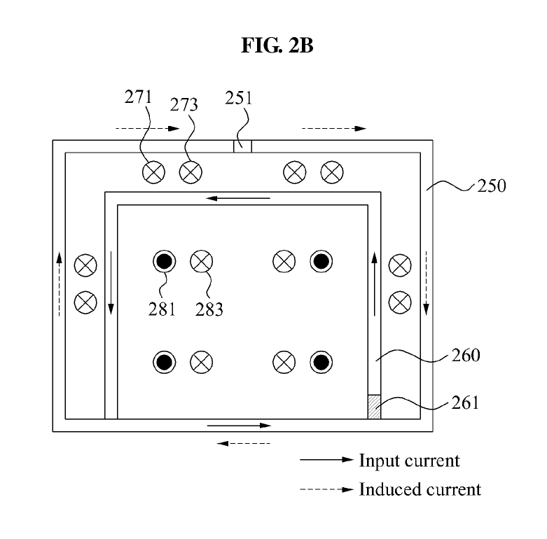

In the following description, the term “resonator” used in the discussion of FIGS. 2A through 4B refers to both a source resonator and a target resonator.

FIGS. 2A and 2B are diagrams illustrating examples of a distribution of a magnetic field in a feeder and a resonator of a wireless power transmitter. When a resonator receives power supplied through a separate feeder, magnetic fields are formed in both the feeder and the resonator.

FIG. 2A illustrates an example of a structure of a wireless power transmitter in which a feeder 210 and a resonator 220 do not have a common ground. Referring to FIG. 2A, as an input current flows into a feeder 210 through a terminal labeled “+” and out of the feeder 210 through a terminal labeled “−”, a magnetic field 230 is formed by the input current. A direction 231 of the magnetic field 230 inside the feeder 210 is into the plane of FIG. 2A, and has a phase that is opposite to a phase of a direction 233 of the magnetic field 230 outside the feeder 210. The magnetic field 230 formed by the feeder 210 induces a current to flow in a resonator 220. The direction of the induced current in the resonator 220 is opposite to a direction of the input current in the feeder 210 as indicated by the dashed arrows in FIG. 2A.

The induced current in the resonator 220 forms a magnetic field 240. Directions of the magnetic field 240 are the same at all positions inside the resonator 220. Accordingly, a direction 241 of the magnetic field 240 formed by the resonator 220 inside the feeder 210 has the same phase as a direction 243 of the magnetic field 240 formed by the resonator 220 outside the feeder 210.

Consequently, when the magnetic field 230 formed by the feeder 210 and the magnetic field 240 formed by the resonator 220 are combined, a strength of the total magnetic field inside the resonator 220 decreases inside the feeder 210 and increases outside the feeder 210. In an example in which power is supplied to the resonator 220 through the feeder 210 configured as illustrated in FIG. 2A, the strength of the total magnetic field decreases in the center of the resonator 220, but increases outside the resonator 220. In another example in which a magnetic field is randomly distributed in the resonator 220, it is difficult to perform impedance matching since an input impedance will frequently vary. Additionally, when the strength of the total magnetic field increases, an efficiency of wireless power transmission increases. Conversely, when the strength of the total magnetic field is decreases, the efficiency of wireless power transmission decreases. Accordingly, the power transmission efficiency may be reduced on average.

FIG. 2B illustrates an example of a structure of a wireless power transmitter in which a resonator 250 and a feeder 260 have a common ground. The resonator 250 includes a capacitor 251. The feeder 260 receives a radio frequency (RF) signal via a port 261. When the RF signal is input to the feeder 260, an input current is generated in the feeder 260. The input current flowing in the feeder 260 forms a magnetic field, and a current is induced in the resonator 250 by the magnetic field. Additionally, another magnetic field is formed by the induced current flowing in the resonator 250. In this example, a direction of the input current flowing in the feeder 260 has a phase opposite to a phase of a direction of the induced current flowing in the resonator 250. Accordingly, in a region between the resonator 250 and the feeder 260, a direction 271 of the magnetic field formed by the input current has the same phase as a direction 273 of the magnetic field formed by the induced current, and thus the strength of the total magnetic field increases in the region between the resonator 250 and the feeder 260. Conversely, inside the feeder 260, a direction 281 of the magnetic field formed by the input current has a phase opposite to a phase of a direction 283 of the magnetic field formed by the induced current, and thus the strength of the total magnetic field decreases inside the feeder 260. Therefore, the strength of the total magnetic field decreases in the center of the resonator 250, but increases outside the resonator 250.

An input impedance may be adjusted by adjusting an internal area of the feeder 260. The input impedance refers to an impedance viewed in a direction from the feeder 260 to the resonator 250. When the internal area of the feeder 260 is increased, the input impedance is increased. Conversely, when the internal area of the feeder 260 is decreased, the input impedance is decreased. Because the magnetic field is randomly distributed in the resonator 250 despite a reduction in the input impedance, a value of the input impedance may vary based on a location of a target device. Accordingly, a separate matching network may be required to match the input impedance to an output impedance of a power amplifier. For example, when the input impedance is increased, a separate matching network may be used to match the increased input impedance to a relatively low output impedance of the power amplifier.

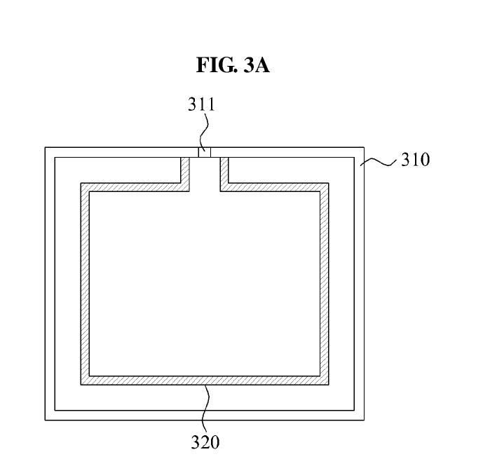

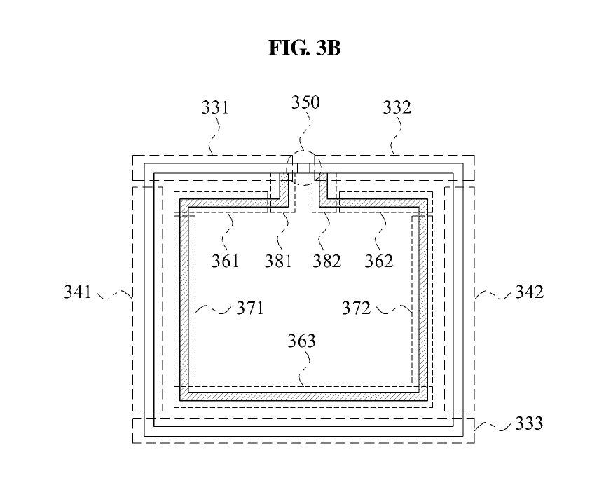

FIGS. 3A and 3B are diagrams illustrating an example of a feeding unit and a resonator of a wireless power transmitter. Referring to FIG. 3A, the wireless power transmitter includes a resonator 310 and a feeding unit 320. The resonator 310 further includes a capacitor 311. The feeding unit 320 is electrically connected to both ends of the capacitor 311.

FIG. 3B illustrates, in greater detail, a structure of the wireless power transmitter of FIG. 3A. The resonator 310 includes a first transmission line (not identified by a reference numeral in FIG. 3B, but formed by various elements in FIG. 3B as discussed below), a first conductor 341, a second conductor 342, and at least one capacitor 350.

The capacitor 350 is inserted in series between a first signal conducting portion 331 and a second signal conducting portion 332, causing an electric field to be confined within the capacitor 350. Generally, a transmission line includes at least one conductor in an upper portion of the transmission line, and at least one conductor in a lower portion of first transmission line. A current may flow through the at least one conductor disposed in the upper portion of the first transmission line, and the at least one conductor disposed in the lower portion of the first transmission line may be electrically grounded. In this example, a conductor disposed in an upper portion of the first transmission line in FIG. 3B is separated into two portions that will be referred to as the first signal conducting portion 331 and the second signal conducting portion 332. A conductor disposed in a lower portion of the first transmission line in FIG. 3B will be referred to as a first ground conducting portion 333.

As illustrated in FIG. 3B, the resonator 310 has a generally two-dimensional (2D) structure. The first transmission line includes the first signal conducting portion 331 and the second signal conducting portion 332 in the upper portion of the first transmission line, and includes the first ground conducting portion 333 in the lower portion of the first transmission line. The first signal conducting portion 331 and the second signal conducting portion 332 are disposed to face the first ground conducting portion 333. A current flows through the first signal conducting portion 331 and the second signal conducting portion 332.

One end of the first signal conducting portion 331 is connected to one end of the first conductor 341, the other end of the first signal conducting portion 331 is connected to the capacitor 350, and the other end of the first conductor 341 is connected to one end of the first ground conducting portion 333. One end of the second signal conducting portion 332 is connected to one end of the second conductor 342, the other end of the second signal conducting portion 332 is connected to the other end of the capacitor 350, and the other end of the second conductor 342 is connected to the other end of the ground conducting portion 333. Accordingly, the first signal conducting portion 331, the second signal conducting portion 332, the first ground conducting portion 333, the first conductor 341, and the second conductor 342 are connected to each other, causing the resonator 310 to have an electrically closed loop structure. The term “loop structure” includes a polygonal structure, a circular structure, a rectangular structure, and any other geometrical structure that is closed, i.e., that does not have any opening in its perimeter. The expression “having a loop structure” indicates a structure that is electrically closed.

The capacitor 350 is inserted into an intermediate portion of the first transmission line. In the example in FIG. 3B, the capacitor 350 is inserted into a space between the first signal conducting portion 331 and the second signal conducting portion 332. The capacitor 350 may be a lumped element capacitor, a distributed capacitor, or any other type of capacitor known to one of ordinary skill in the art. For example, a distributed element capacitor may include a zigzagged conductor line and a dielectric material having a relatively high permittivity disposed between parallel portions of the zigzagged conductor line.

The capacitor 350 inserted into the first transmission line may cause the resonator 310 to have a characteristic of a metamaterial. A metamaterial is a material having a predetermined electrical property that is not found in nature, and thus may have an artificially designed structure. All materials existing in nature have a magnetic permeability and permittivity. Most materials have a positive magnetic permeability and/or a positive permittivity.

For most materials, a right-hand rule may be applied to an electric field, a magnetic field, and a Poynting vector of the materials, so the materials may be referred to as right-handed materials (RHMs). However, a metamaterial that has a magnetic permeability and/or a permittivity that is not found in nature, and may be classified into an epsilon negative (ENG) material, a mu negative (MNG) material, a double negative (DNG) material, a negative refractive index (NRI) material, a left-handed (LH) material, and other metamaterial classifications known to one of ordinary skill in the art based on a sign of the magnetic permeability of the metamaterial and a sign of the permittivity of the metamaterial.

If the capacitor 350 is a lumped element capacitor and a capacitance of the capacitor 350 is appropriately determined, the resonator 310 may have a characteristic of a metamaterial. If the resonator 310 is caused to have a negative magnetic permeability by appropriately adjusting the capacitance of the capacitor 350, the resonator 310 may also be referred to as an MNG resonator. Various criteria may be applied to determine the capacitance of the capacitor 350. For example, the various criteria may include a criterion for enabling the resonator 310 to have the characteristic of the metamaterial, a criterion for enabling the resonator 310 to have a negative magnetic permeability at a target frequency, a criterion for enabling the resonator 310 to have a zeroth order resonance characteristic at the target frequency, and any other suitable criterion. Based on any one or any combination of the aforementioned criteria, the capacitance of the capacitor 350 may be appropriately determined.

The resonator 310, hereinafter referred to as the MNG resonator 310, may have a zeroth order resonance characteristic of having a resonance frequency when a propagation constant is “0”. If the MNG resonator 310 has the zeroth order resonance characteristic, the resonance frequency is independent of a physical size of the MNG resonator 310. By changing the capacitance of the capacitor 350, the resonance frequency of the MNG resonator 310 may be changed without changing the physical size of the MNG resonator 310.

In a near field, the electric field is concentrated in the capacitor 350 inserted into the first transmission line, causing the magnetic field to become dominant in the near field. The MNG resonator 310 has a relatively high Q-factor when the capacitor 350 is a lumped element, thereby increasing a power transmission efficiency. The Q-factor indicates a level of an ohmic loss or a ratio of a reactance with respect to a resistance in the wireless power transmission. As will be understood by one of ordinary skill in the art, the efficiency of the wireless power transmission will increase as the Q-factor increases.

Although not illustrated in FIG. 3B, a magnetic core passing through the MNG resonator 310 may be provided to increase a power transmission distance.

Referring to FIG. 3B, the feeding unit 320 includes a second transmission line (not identified by a reference numeral in FIG. 3B, but formed by various elements in FIG. 3B as discussed below), a third conductor 371, a fourth conductor 372, a fifth conductor 381, and a sixth conductor 382.

The second transmission line includes a third signal conducting portion 361 and a fourth signal conducting portion 362 in an upper portion of the second transmission line, and includes a second ground conducting portion 363 in a lower portion of the second transmission line. The third signal conducting portion 361 and the fourth signal conducting portion 362 are disposed to face the second ground conducting portion 363. A current flows through the third signal conducting portion 361 and the fourth signal conducting portion 362.

One end of the third signal conducting portion 361 is connected to one end of the third conductor 371, the other end of the third signal conducting portion 361 is connected to one end of the fifth conductor 381, and the other end of the third conductor 371 is connected to one end of the second ground conducting portion 363. One end of the fourth signal conducting portion 362 is connected to one end of the fourth conductor 372, the other end of the fourth signal conducting portion 362 is connected to one end the sixth conductor 382, and the other end of the fourth conductor 372 is connected to the other end of the second ground conducting portion 363. The other end of the fifth conductor 381 is connected to the first signal conducting portion 331 at or near where the first signal conducting portion 331 is connected to one end of the capacitor 350, and the other end of the sixth conductor 382 is connected to the second signal conducting portion 332 at or near where the second signal conducting portion 332 is connected to the other end of the capacitor 350. Thus, the fifth conductor 381 and the sixth conductor 382 are connected in parallel to both ends of the capacitor 350. The fifth conductor 381 and the sixth conductor 382 are used as an input port to receive an RF signal as an input.

Accordingly, the third signal conducting portion 361, the fourth signal conducting portion 362, the second ground conducting portion 363, the third conductor 371, the fourth conductor 372, the fifth conductor 381, the sixth conductor 382, and the resonator 310 are connected to each other, causing the resonator 310 and the feeding unit 320 to have an electrically closed loop structure. The term “loop structure” includes a polygonal structure, a circular structure, a rectangular structure, and any other geometrical structure that is closed, i.e., that does not have any opening in its perimeter. The expression “having a loop structure” indicates a structure that is electrically closed.

If an RF signal is input to the fifth conductor 381 or the sixth conductor 382, input current flows through the feeding unit 320 and the resonator 310, generating a magnetic field that induces a current in the resonator 310. A direction of the input current flowing through the feeding unit 320 is identical to a direction of the induced current flowing through the resonator 310, thereby causing a strength of a total magnetic field to increase in the center of the resonator 310, and decrease near the outer periphery of the resonator 310.

An input impedance is determined by an area of a region between the resonator 310 and the feeding unit 320. Accordingly, a separate matching network used to match the input impedance to an output impedance of a power amplifier may not be necessary. However, if a matching network is used, the input impedance may be adjusted by adjusting a size of the feeding unit 320, and accordingly a structure of the matching network may be simplified. The simplified structure of the matching network may reduce a matching loss of the matching network.

The second transmission line, the third conductor 371, the fourth conductor 372, the fifth conductor 381, and the sixth conductor 382 of the feeding unit may have a structure identical to the structure of the resonator 310. For example, if the resonator 310 has a loop structure, the feeding unit 320 may also have a loop structure. As another example, if the resonator 310 has a circular structure, the feeding unit 320 may also have a circular structure.

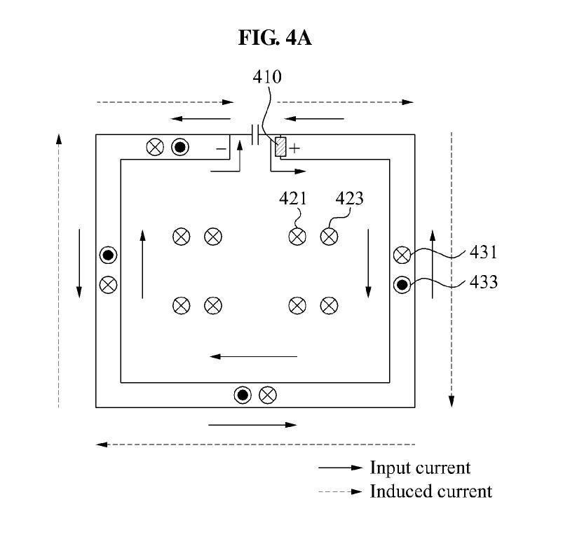

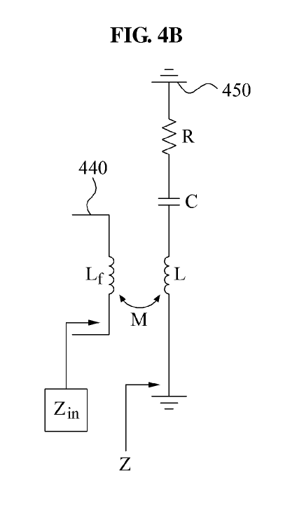

FIG. 4A is a diagram illustrating an example of a distribution of a magnetic field in a resonator that is produced by feeding of a feeding unit, of a wireless power transmitter. FIG. 4A more simply illustrates the resonator 310 and the feeding unit 320 of FIGS. 3A and 3B, and the names of the various elements in FIG. 3B will be used in the following description of FIG. 4A without reference numerals.

A feeding operation may be an operation of supplying power to a source resonator in wireless power transmission, or an operation of supplying AC power to a rectifier in wireless power transmission. FIG. 4A illustrates a direction of input current flowing in the feeding unit, and a direction of induced current flowing in the source resonator. Additionally, FIG. 4A illustrates a direction of a magnetic field formed by the input current of the feeding unit, and a direction of a magnetic field formed by the induced current of the source resonator.

Referring to FIG. 4A, the fifth conductor or the sixth conductor of the feeding unit 320 may be used as an input port 410. In FIG. 4A, the sixth conductor of the feeding unit is being used as the input port 410. An RF signal is input to the input port 410. The RF signal may be output from a power amplifier. The power amplifier may increase and decrease an amplitude of the RF signal based on a power requirement of a target device. The RF signal input to the input port 410 is represented in FIG. 4A as an input current flowing in the feeding unit. The input current flows in a clockwise direction in the feeding unit along the second transmission line of the feeding unit. The fifth conductor and the sixth conductor of the feeding unit are electrically connected to the resonator. More specifically, the fifth conductor of the feeding unit is connected to the first signal conducting portion of the resonator, and the sixth conductor of the feeding unit is connected to the second signal conducting portion of the resonator. Accordingly, the input current flows in both the resonator and the feeding unit. The input current flows in a counterclockwise direction in the resonator along the first transmission line of the resonator. The input current flowing in the resonator generates a magnetic field, and the magnetic field induces a current in the resonator due to the magnetic field. The induced current flows in a clockwise direction in the resonator along the first transmission line of the resonator. The induced current in the resonator transfers energy to the capacitor of the resonator, and also generates a magnetic field. In FIG. 4A, the input current flowing in the feeding unit and the resonator is indicated by solid lines with arrowheads, and the induced current flowing in the resonator is indicated by dashed lines with arrowheads.

A direction of a magnetic field generated by a current is determined based on the right-hand rule. As illustrated in FIG. 4A, within the feeding unit, a direction 421 of the magnetic field generated by the input current flowing in the feeding unit is identical to a direction 423 of the magnetic field generated by the induced current flowing in the resonator. Accordingly, a strength of the total magnetic field may increases inside the feeding unit.

In contrast, as illustrated in FIG. 4A, in a region between the feeding unit and the resonator, a direction 433 of the magnetic field generated by the input current flowing in the feeding unit is opposite to a direction 431 of the magnetic field generated by the induced current flowing in the resonator. Accordingly, the strength of the total magnetic field decreases in the region between the feeding unit and the resonator.

Typically, in a resonator having a loop structure, a strength of a magnetic field decreases in the center of the resonator, and increases near an outer periphery of the resonator. However, referring to FIG. 4A, since the feeding unit is electrically connected to both ends of the capacitor of the resonator, the direction of the induced current in the resonator is identical to the direction of the input current in the feeding unit. Since the direction of the induced current in the resonator is identical to the direction of the input current in the feeding unit, the strength of the total magnetic field increases inside the feeding unit, and decreases outside the feeding unit. As a result, due to the feeding unit, the strength of the total magnetic field increases in the center of the resonator having the loop structure, and decreases near an outer periphery of the resonator, thereby compensating for the normal characteristic of the resonator having the loop structure in which the strength of the magnetic field decreases in the center of the resonator, and increases near the outer periphery of the resonator. Thus, the strength of the total magnetic field may be constant inside the resonator.

A power transmission efficiency for transferring wireless power from a source resonator to a target resonator is proportional to the strength of the total magnetic field generated in the source resonator. Accordingly, when the strength of the total magnetic field increases inside the source resonator, the power transmission efficiency also increases.

FIG. 4B is a diagram illustrating examples of equivalent circuits of a feeding unit and a resonator of a wireless power transmitter. Referring to FIG. 4B, a feeding unit 440 and a resonator 450 may be represented by the equivalent circuits in FIG. 4B. The feeding unit 440 is represented as an inductor having an inductance L_{f}, and the resonator 450 is represented as a series connection of an inductor having an inductance L coupled to the inductance L_{f} of the feeding unit 440 by a mutual inductance M, a capacitor having a capacitance C, and a resistor having a resistance R. An example of an input impedance Zᵢₙ viewed in a direction from the feeding unit 440 to the resonator 450 may be expressed by the following Equation 1:

$${Z}_{i n} = \frac{{( ω M )}^{2}}{Z} \qquad ( 1 )$$

In Equation 1, M denotes a mutual inductance between the feeding unit 440 and the resonator 450, ω denotes a resonance frequency of the feeding unit 440 and the resonator 450, and Z denotes an impedance viewed in a direction from the resonator 450 to a target device. As can be seen from Equation 1, the input impedance Zᵢₙ is proportional to the square of the mutual inductance M. Accordingly, the input impedance Zᵢₙ may be adjusted by adjusting the mutual inductance M. The mutual inductance M depends on an area of a region between the feeding unit 440 and the resonator 450. The area of the region between the feeding unit 440 and the resonator 450 may be adjusted by adjusting a size of the feeding unit 440, thereby adjusting the mutual inductance M and the input impedance Zᵢₙ. Since the input impedance Zᵢₙ may be adjusted by adjusting the size of the feeding unit 440, it may be unnecessary to use a separate matching network to perform impedance matching with an output impedance of a power amplifier.

In a target resonator and a feeding unit included in a wireless power receiver, a magnetic field may be distributed as illustrated in FIG. 4A. For example, the target resonator may receive wireless power from a source resonator via magnetic coupling. The received wireless power induces a current in the target resonator. The induced current in the target resonator generates a magnetic field, which induces a current in the feeding unit. If the target resonator is connected to the feeding unit as illustrated in FIG. 4A, a direction of the induced current flowing in the target resonator will be identical to a direction of the induced current flowing in the feeding unit. Accordingly, for the reasons discussed above in connection with FIG. 4A, a strength of the total magnetic field will increase inside the feeding unit, and will decrease in a region between the feeding unit and the target resonator.

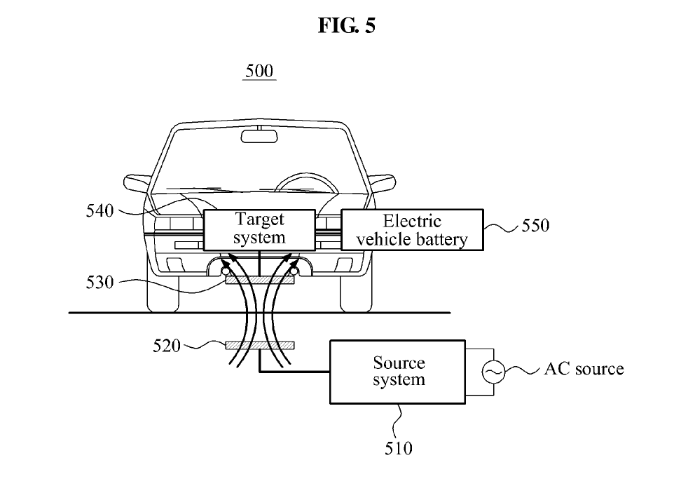

FIG. 5 is a diagram illustrating an example of an electric vehicle charging system. Referring to FIG. 5, an electric vehicle charging system 500 includes a source system 510, a source resonator 520, a target resonator 530, a target system 540, and an electric vehicle battery 550.

In one example, the electric vehicle charging system 500 has a structure similar to the structure of the wireless power transmission system of FIG. 1. The source system 510 and the source resonator 520 in the electric vehicle charging system 500 operate as a source. The target resonator 530 and the target system 540 in the electric vehicle charging system 500 operate as a target.

In one example, the source system 510 includes an alternating current-to-direct current (AC/DC) converter, a power detector, a power converter, a control and communication (control/communication) unit similar to those of the source device 110 of FIG. 1. In one example, the target system 540 includes a rectifier, a DC-to-DC (DC/DC) converter, a switch, a charging unit, and a control/communication unit similar to those of the target device 120 of FIG. 1. The electric vehicle battery 550 is charged by the target system 540. The electric vehicle charging system 500 may use a resonant frequency in a band of a few kHz to tens of MHz.

The source system 510 generates power based on a type of the vehicle being charged, a capacity of the electric vehicle battery 550, and a charging state of the electric vehicle battery 550, and wirelessly transmits the generated power to the target system 540 via a magnetic coupling between the source resonator 520 and the target resonator 530.

The source system 510 may control an alignment of the source resonator 520 and the target resonator 530. For example, when the source resonator 520 and the target resonator 530 are not aligned, the controller of the source system 510 may transmit a message to the target system 540 to control the alignment of the source resonator 520 and the target resonator 530.

For example, when the target resonator 530 is not located in a position enabling maximum magnetic coupling, the source resonator 520 and the target resonator 530 are not properly aligned. When a vehicle does not stop at a proper position to accurately align the source resonator 520 and the target resonator 530, the source system 510 may instruct a position of the vehicle to be adjusted to control the source resonator 520 and the target resonator 530 to be aligned. However, this is just an example, and other methods of aligning the source resonator 520 and the target resonator 530 may be used.

The source system 510 and the target system 540 may transmit or receive an ID of a vehicle and exchange various messages by performing communication with each other.

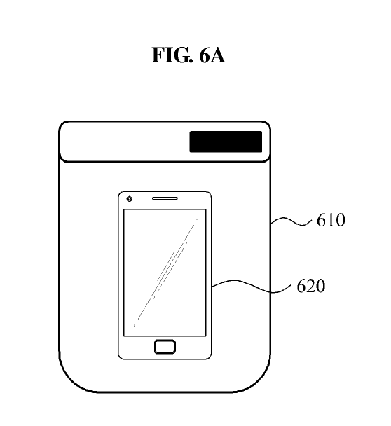

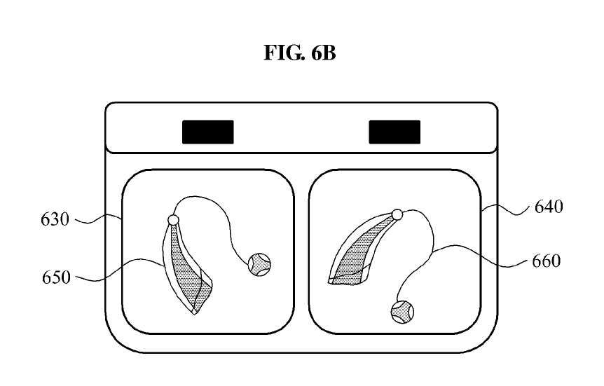

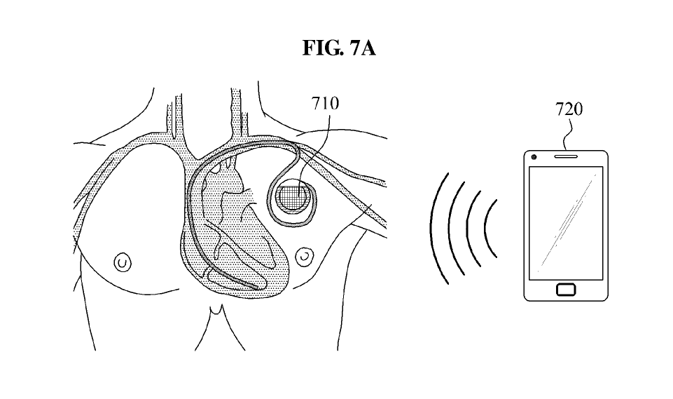

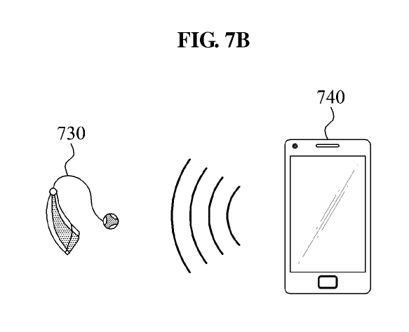

The descriptions of FIGS. 2 through 4B are also applicable to the electric vehicle charging system 500. However, the electric vehicle charging system 500 may use a resonant frequency in a band of a few kHz to tens of MHz, and may wirelessly transmit power that is equal to or higher than tens of watts to charge the electric vehicle battery 550. FIG. 6A through 7B are diagrams illustrating examples of applications in which a wireless power receiver and a wireless power transmitter are mounted. FIG. 6A illustrates an example of wireless power charging between a pad 610 and a mobile terminal 620, and FIG. 6B illustrates an example of wireless power charging between pads 630 and 640 and hearing aids 650 and 660, respectively.

Referring to FIG. 6A, a wireless power transmitter is mounted in the pad 610, and a wireless power receiver is mounted in the mobile terminal 620. The pad 610 charges a single mobile terminal, namely, the mobile terminal 620.

Referring to FIG. 6B, two wireless power transmitters are respectively mounted in the pads 630 and 640. The hearing aids 650 and 660 are used for a left ear and a right ear, respectively. Two wireless power receivers are respectively mounted in the hearing aids 650 and 660. The pads 630 and 640 charge two hearing aids, respectively, namely, the hearing aids 650 and 660.

FIG. 7A illustrates an example of wireless power charging between an electronic device 710 inserted into a human body, and a mobile terminal 720. FIG. 7B illustrates an example of wireless power charging between a hearing aid 730 and a mobile terminal 740.

Referring to FIG. 7A, a wireless power transmitter and a wireless power receiver are mounted in the mobile terminal 720. Another wireless power receiver is mounted in the electronic device 710. The electronic device 710 is charged by receiving power from the mobile terminal 720.

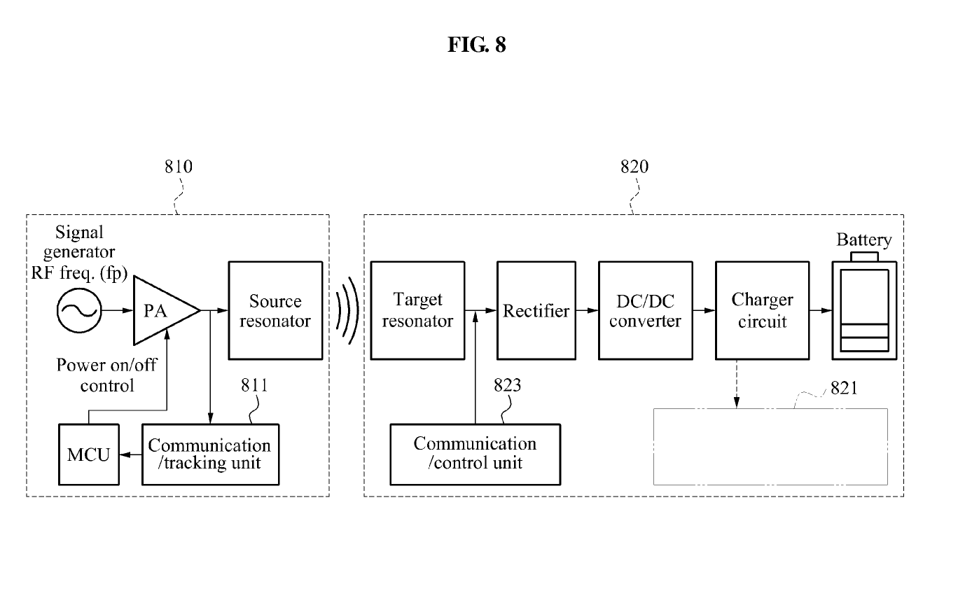

Referring to FIG. 7B, a wireless power transmitter and a wireless power receiver are mounted in the mobile terminal 740. Another wireless power receiver is mounted in the hearing aid 730. The hearing aid 730 is charged by receiving power from the mobile terminal 740. Low-power electronic devices, for example, Bluetooth earphones, may also be charged by receiving power from the mobile terminal 740. FIG. 8 is a diagram illustrating another example of a wireless power transmission system. Referring to FIG. 8, a wireless power transmitter 810 may be mounted in each of the pad 610 of FIG. 6A and pads 630 and 640 of FIG. 6B. Additionally, the wireless power transmitter 810 may be mounted in each of the mobile terminal 720 of FIG. 7A and the mobile terminal 740 of FIG. 7B.

In addition, a wireless power receiver 820 may be mounted in each of the mobile terminal 620 of FIG. 6A and the hearing aids 650 and 660 of FIG. 6B. Further, the wireless power receiver 820 may be mounted in each of the electronic device 710 of FIG. 7A and the hearing aid 730 of FIG. 7B.

The wireless power transmitter 810 may include a similar configuration to the source device 110 of FIG. 1. For example, the wireless power transmitter 810 may include a unit configured to transmit power using magnetic coupling.

Referring to FIG. 8, the wireless power transmitter 810 includes a signal generator that generates a radio frequency (RF) frequency fp, a power amplifier (PA), a microcontroller unit (MCU), a source resonator, and a communication/tracking unit 811. The communication/tracking unit 811 communicates with the wireless power receiver 820, and controls an impedance and a resonance frequency to maintain a wireless power transmission efficiency. Additionally, the communication/tracking unit 811 may perform similar functions to the power converter 114 and the control/communication unit 115 of FIG. 1.

The wireless power receiver 820 may include a similar configuration to the target device 120 of FIG. 1. For example, the wireless power receiver 820 may include a unit configured to wirelessly receive power and to charge a battery.

Referring to FIG. 8, the wireless power receiver 820 includes a target resonator, a rectifier, a DC/DC converter, a charger circuit, and a communication/control unit 823. The communication/control unit 823 communicates with the wireless power transmitter 810, and performs an operation to protect overvoltage and overcurrent.

The wireless power receiver 820 may include a hearing device circuit 821. The hearing device circuit 821 may be charged by a battery. The hearing device circuit 821 may include, for example, a microphone, an analog-to-digital converter (ADC), a processor, a digital-to-analog converter (DAC), and/or a receiver. For example, the hearing device circuit 821 may include the same configuration as a hearing aid.

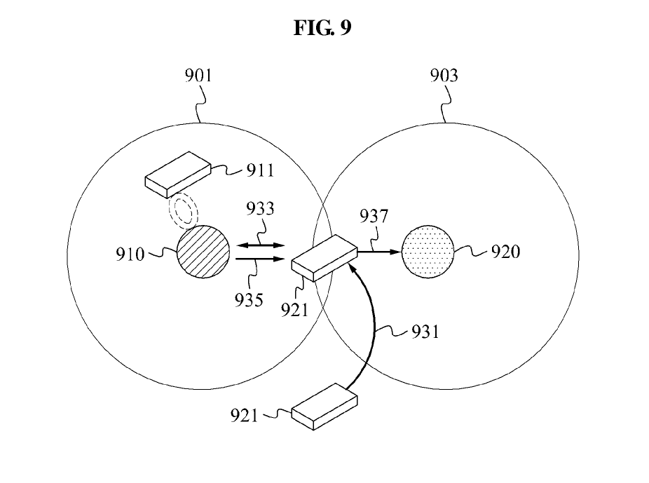

FIG. 9 is a diagram illustrating an example of a multi-source environment. Referring to FIG. 9, the multi-source environment includes a plurality of source devices, for example, source devices 910 and 920. The source devices 910 and 920 may be individually installed in separate apparatuses, or may be installed in a single apparatus, e.g., in the respective pads 630 and 640 of FIG. 6B.

An efficient power transmission region 901 of the source device 910, and an efficient power transmission region 903 of the source device 920, may be set so that the efficient power transmission regions 901 and 903 do not overlap. The term “efficient power transmission region” refers to a region in which a predetermined power transmission efficiency may be guaranteed. For example, a target device 911 or 921 may efficiently receive wireless power from the source device 910, because the target device 911 or 921 is located within the efficient power transmission region 901. Additionally, a target device (e.g., 921) located near a boundary between the efficient power transmission regions 901 and 903 may receive wake-up power from at least one of the source devices 910 and 920. If the multi-source environment uses an out-band communication scheme, a communication coverage of the source device 910 may be set to be wider than the efficient power transmission region 901.

The source devices 910 and 920 may detect the target devices 911 and/or 921 based on a power transmission efficiency between devices and/or other factors known to one of ordinary skill in the art. Additionally, the source devices 910 and 920 may restrict the target devices 911 and/or 921 from access to the source devices 910 and 920, for example, to wireless power transmission, based on circumstances. The target devices 911 and 921 may access the source devices 910 and/or 920 with good power transmission efficiencies.

For example, in operation 931, the target device 921 moves toward the boundary between the efficient power transmission regions 901 and 903. The target device 921 may receive wake-up power from at least one of the source devices 910 and 920. The target device 921 may activate a communication function and a control function of the target device 921, using the wake-up power.

In this example, the target device 921 may receive notice information from each of the source devices 910 and 920. The target device 921 may further measure and compare received signal strength indications (RSSIs) of signals for the received notice information, and may transmit a search signal to the source device 910 or 920 with the higher RSSI. The notice information may include a network ID of the source device 910 or 920. The search signal may be used to join a communication and power transmission network of the source device 910 or 920. The search signal may include the network ID of the source device 910 or 920 with the higher RSSI value. Accordingly, the target device 921 may access the source device 910 or 920.

In this example, the source device 910 may determine whether the target device 921 incorrectly accesses (e.g., is to cease accessing) the source device 910, and may restrict the target device 921 from access to the source device 910 based on the determination. In more detail, in operation 933, the source device 910 detects the target device 921, and the target device 921 accesses the source device 910 through communication, as described with reference to operation 931. The source device 910 further determines whether the target device 921 incorrectly accesses the source device 910.

If the target device 921 is determined to incorrectly access the source device 910, in operation 935, the source device 910 transmits a reset command to the target device 921. By transmitting the reset command to the target device 921, the source device 910 restricts the target device 921 from access to the source device 910 to reduce an amount of transmitted power for a predetermined period of time, and to prevent the target device 9210 from incorrectly accessing the source device 910. In response to the reset command, the target device 921 resets the target device 921, e.g., ceases to access the source device 910.

If the target device 921 is reset, in operation 937, the target device 921 detects the source device 920, and accesses the source device 920 through communication, as similarly described with reference to operation 931. Accordingly, a target device that incorrectly accesses a source device, or that includes a poor power transmission efficiency with a source device, may be detected, and an efficient multi-source environment may be configured.

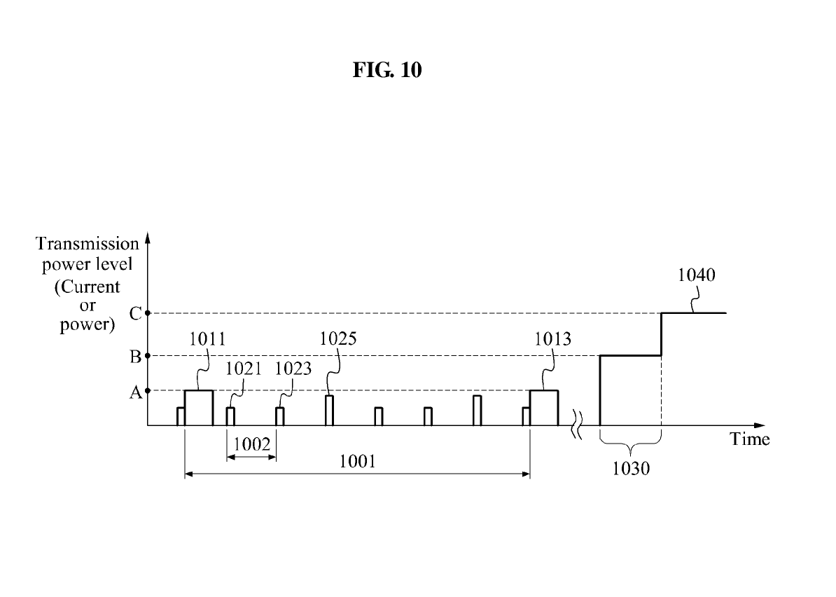

FIG. 10 is a diagram illustrating an example of a method of controlling power in a wireless power transmitter. To configure a communication network for wireless power transmission, the wireless power transmitter may periodically broadcast notice information. The wireless power transmitter may further transmit wake-up power, while transmitting the notice information, or regardless of a transmission period of the notice information.

Referring to FIG. 10, a transmission power level may correspond to power output from a PA of the wireless power transmitter. Alternatively, the transmission power level may correspond to current input to the PA.

Power with a transmission power level A represents wake-up power. For example, each of power 1011 and 1013 with the transmission power level A represents wake-up power.

Power with a transmission power level less than the transmission power level A represents detection power. For example, each of power 1021, 1023, and 1025 with respective transmission power levels less than the transmission power level A represents detection power. Accordingly, to generate wake-up power, the wireless power transmitter may supply, to the PA, current greater than current used to generate detection power.

A transmission period 1001 of the wake-up power 1011 (e.g., a time duration in which the wireless power transmitter transmits the wake-up power 1011) is set to be longer than a transmission period 1002 of the detection power 1021 (e.g., a time duration in which the wireless power transmitter transmits the detection power 1021). In other words, during the transmission period 1001, the detection power may be transmitted.

The wireless power transmitter may transmit wake-up power to a wireless power receiver, to activate a communication function and a control function of the wireless power receiver. Further, the wireless power transmitter may detect a change in an impedance or a change in a load of a source resonator of the wireless power transmitter, and may detect the wireless power receiver, using the detection power. Accordingly, the wireless power transmitter may quickly detect a wireless power receiver, despite a transmission period of wake-up power being set to be long for protection of a wireless power transmission system.

Unlike FIG. 10, a transmission power level of detection power may be greater than a transmission power level of wake-up power. However, a transmission period of detection power may be less than a transmission period of wake-up power. For example, if the transmission period 1002 of the detection power 1021 is about 1 millisecond (ms), the transmission period 1001 of the wake-up power 1011 may be about 5 ms to about 10 ms.

Further, the wireless power transmitter may communicate with the wireless power receiver, and may then increase an amount of current supplied to the PA, to transmit operation power or charging power to the wireless power receiver. In more detail, the wireless power transmitter may determine power to be consumed in the wireless power receiver through the communication, and may control the amount of current supplied to the PA based on the power to be consumed and a power transmission efficiency between the wireless power transmitter and the wireless power receiver. For example, if the power transmission efficiency is about 90%, and the power to be consumed is about 5 W, the wireless power transmitter may supply power of at least about 5.6 W to the source resonator. The power supplied to the source resonator may be transmitted to a target resonator of the wireless power receiver through magnetic resonant coupling.

Further, the wireless power transmitter may determine the power transmission efficiency, by receiving, from the wireless power receiver, information on an amount of wake-up power received by the wireless power receiver. The power transmission efficiency may be calculated based on the received information and an amount of wake-up power transmitted by the wireless power transmitter.

Further, the wireless power transmitter may gradually increase an amount of power supplied to the source resonator, or the amount of current supplied to the PA, to protect the wireless power transmission system. For example, current B supplied to the PA in a time duration 1030 (e.g., a transmission period of operation power) is increased to current C supplied to the PA in a time duration 1040 (e.g., another transmission period of operation power).

A transmission period of detection power, and a transmission period of wake-up power, may be variably set, and may be inserted between transmission periods of operation power. For example, if the time duration 1040 lasts for a few seconds, a transmission period of detection power, and a transmission period of wake-up power, may be inserted, and afterwards, the time duration 1040 may again last for a few seconds.

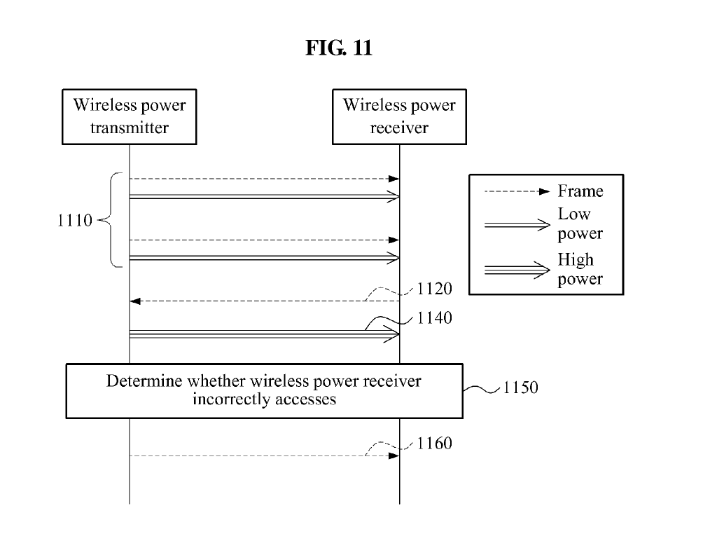

FIG. 11 is a flowchart illustrating an example of a method of performing communication and controlling power in a magnetic resonant wireless power transmission system. Referring to FIG. 11, in operations 1110 and 1120, a wireless power transmitter transmits notice information to a wireless power receiver, and detects the wireless power receiver based on the notice information, and the wireless power receiver accesses the wireless power transmitter through communication.

In more detail, referring to FIGS. 9 and 10, the source device 910 may periodically broadcast notice information, regardless of power control. The source device 910 may detect the target device 911 based on the notice information, and may control power to be transmitted in the duration 1040. If the source device 910 may perform out-band communication, the source device 910 may periodically broadcast a frame corresponding to the notice information, regardless of power control.

Referring again to FIG. 11, in operation 1110, the wireless power transmitter periodically transmits, to the wireless power receiver, at least one frame corresponding to the notice information, regardless of power control, e.g., regardless that the wireless power transmitter is transmitting low power. The notice information may include a network ID of the wireless power transmitter that is used in a network of the magnetic resonant wireless power transmission system. The low power may include detection power and wake-up power. A transmission period of the frame may be identical to, or different from, a transmission period of the low power.

In this example, the wireless power receiver receives wake-up power, and activates a communication function and a control function of the wireless power receiver based on the wake-up power. When the communication function and control function are activated, in operation 1120, the wireless power receiver transmits a search signal to the wireless power transmitter. If frames corresponding to notice information are received from a plurality of wireless power transmitters, the wireless power receiver may measure RSSIs associated with the frames, and may transmit a search signal to a wireless power transmitter with the highest RSSI. The search signal may include a network ID of the wireless power transmitter with the highest RSSI and included in the notice information.

In this example, the wireless power transmitter detects the wireless power receiver based on the search signal, and the wireless power receiver accesses the wireless power transmitter through the communication. In more detail, the wireless power transmitter compares the network ID included in the received search signal with the network ID included in the broadcasted notice information. Based on the comparison, the wireless power transmitter determines whether to allow the wireless power receiver to access the wireless power transmitter. When the network ID included in the received search signal is matched to the network ID of the wireless power transmitter, the wireless power transmitter may transmit an acknowledgement (ACK) signal corresponding to the search signal, to allow the wireless power receiver to access the wireless power transmitter. That is, the ACK signal may be a response signal corresponding to the search signal. The wireless power transmitter may further assign an ID to the wireless power receiver.

If the response signal corresponding to the search signal is received, the wireless power receiver may transmit, to the wireless power transmitter, another search signal used to join the network of the wireless power transmitter. To distinguish the other search signal from the search signal transmitted in operation 1120, the other search signal may also be referred to as a “request join signal”. For example, the request join signal, instead of the search signal, may include the network ID. In this example, the search signal may be used by the wireless power receiver to search for a wireless power transmitter.

If the request join signal is received, the wireless power transmitter may compare the network ID included in the received request join signal with the network ID of the wireless power transmitter. Based on the comparison, the wireless power transmitter may determine whether to allow the wireless power receiver to access the wireless power transmitter. When the network ID included in the received request join signal is matched to the network ID of the wireless power transmitter, the wireless power transmitter may allow the wireless power receiver to access the wireless power transmitter.

For example, each of the search signal and the request join signal may include a variety of information regarding the wireless power receiver. The variety of information regarding the wireless power receiver may include, for example, a product type of a corresponding target device, information about a manufacturer of a corresponding target device, a model name of a corresponding target device, a battery type of a corresponding target device, a scheme of charging a corresponding target device, an impedance value of a load of a corresponding target device, information on characteristics of a target resonator of a corresponding target device, information on a frequency band used by a corresponding target device, an amount of a power consumed by a corresponding target device, an ID of a corresponding target device, and/or information on product version or standard of a corresponding target device.

In operation 1140, the wireless power transmitter transmits high power to the wireless power receiver, by increasing an amount of current supplied to an PA of the wireless power transmitter. For example, the high power may be transmitted in the durations 1030 and/or 1040 of FIG. 10.

In operation 1150, the wireless power transmitter determines whether the wireless power receiver incorrectly accesses (e.g., is to cease accessing) the wireless power transmitter, e.g., incorrectly receives the high power from the wireless power transmitter. For example, the wireless power transmitter may determine whether the wireless power receiver incorrectly accesses the wireless power transmitter based on power control of the wireless power transmitter and/or a power transmission efficiency between the wireless power transmitter and the wireless power receiver.

For example, the wireless power transmitter may change power supplied to a source resonator of the wireless power transmitter based on a predetermined timing, and may receive, from the wireless power receiver, information on a change in power received at the wireless power receiver. The wireless power transmitter may further determine whether the information on the change in the received power is matched to the change in the supplied power to determine whether the wireless power receiver incorrectly accesses the wireless power transmitter. In this example, if the information on the change in the received power is not matched to the change in the supplied power, the wireless power transmitter may determine that the wireless power receiver incorrectly accesses the wireless power transmitter.

In another example, the wireless power transmitter may generate operation power to be used to operate the wireless power receiver, and may transmit the operation power to the wireless power receiver. The wireless power transmitter may further receive, from the wireless power receiver, information on an amount of power received at the wireless power receiver, and may compare an amount of the operation power with the amount of the received power to determine whether the wireless power receiver incorrectly accesses the wireless power transmitter. In this example, if the wireless power transmitter transmits, to the wireless power receiver, operation power of about 5.6 W, and the wireless power receiver receives, from the wireless power receiver, information on an amount of power received at the wireless power receiver being about 2 W, the wireless power transmitter may determine that the wireless power receiver incorrectly accesses the wireless power transmitter.

In still another example, the wireless power transmitter may transmit, to the wireless power receiver, information on an amount of power transmitted to the wireless power receiver, and may receive, from the wireless power receiver, information on a power transmission efficiency between the wireless power transmitter and the wireless power receiver. The wireless power transmitter may compare the received power transmission efficiency with a power transmission efficiency allowed in the magnetic resonant wireless power transmission system to determine whether the wireless power receiver incorrectly accesses the wireless power transmitter. In this example, the wireless power transmitter may notify the wireless power receiver that power of about 5.6 W is currently transmitted to the wireless power receiver. The wireless power receiver may measure current and voltage between a target resonator and a rectification unit of the wireless power receiver, in an output end of the rectification unit, and/or in an input end of a battery of the wireless power receiver. The wireless power receiver may calculate the power transmission efficiency based on the measured current, the measured voltage, and the amount of power transmitted to the wireless power receiver, and may transmit the power transmission efficiency to the wireless power transmitter. If the power transmission efficiency is less than or equal to about 70%, which is allowed in the wireless power transmission system, the wireless power transmitter may determine that the wireless power receiver incorrectly accesses the wireless power transmitter.

In yet another example, the wireless power transmitter may receive, from the wireless power receiver, information on an amount of power received at the wireless power receiver, and may calculate a power transmission efficiency between the wireless power transmitter and the wireless power receiver based on the information on the amount of the received power and an amount of power transmitted to the wireless power receiver. The wireless power transmitter may further compare the calculated power transmission efficiency with a power transmission efficiency allowed in the magnetic resonant wireless power transmission system to determine whether the wireless power receiver incorrectly accesses the wireless power transmitter. In this example, if the calculated power transmission efficiency is less than or equal to the allowed power transmission efficiency, the wireless power transmitter may determine that the wireless power receiver incorrectly accesses the wireless power transmitter.

In a further example, the wireless power transmitter may receive, from the wireless power receiver, RSSI of a signal transmitted by the wireless power transmitter to the wireless power receiver, and may compare the RSSI with a predetermined value to determine whether the wireless power receiver incorrectly accesses the wireless power transmitter. The RSSI may be associated with notice information or an ACK signal that is transmitted from the wireless power transmitter to the wireless power receiver. In this example, if the received RSSI is less than the predetermined value, the wireless power transmitter may determine that the wireless power receiver incorrectly accesses the wireless power transmitter.

When the wireless power receiver is determined to incorrectly access the wireless power transmitter, in operation 1160, the wireless power transmitter transmits a reset command to the wireless power receiver. For example, prior to receiving the reset command, the wireless power receiver may measure the RSSI of the signal received from the wireless power transmitter, and may transmit the measured RSSI to the wireless power transmitter.

In another example, prior to receiving the reset command, the wireless power receiver may measure a change in power received from the wireless power transmitter, and may transmit, to the wireless power transmitter, information on the change in the received power. The change in the received power may include a change in current and/or a change in voltage. Additionally or alternatively, the change in the received power may be measured between the target resonator and the rectification unit, in the output end of the rectification unit, and/or in the input end of the battery.

In still another example, prior to receiving the reset command, the wireless power receiver may receive operation power from the wireless power transmitter, and may transmit, to the wireless power transmitter, information on an amount of the received operation power. The information on the amount of the received operation power may include information on an amount of current. The amount of the current may be measured between the target resonator and the rectification unit, in the output end of the rectification unit, and/or in the input end of the battery.

In yet another example, prior to receiving the reset command, the wireless power receiver may receive, from the wireless power transmitter, information on an amount of power transmitted by the wireless power transmitter, may calculate a power transmission efficiency between the wireless power transmitter and the wireless power receiver based on the information on the amount of the transmitted power and an amount of power received at the wireless power receiver. The wireless power receiver may further transmit, to the wireless power transmitter, information on the calculated power transmission efficiency.

In a further example, the wireless power receiver may determine whether the wireless power receiver incorrectly accesses the wireless power transmitter based on information received from the wireless power transmitter. In this example, the wireless power receiver may receive, from the wireless power transmitter, information on an amount of power output from the PA or the source resonator of the wireless power transmitter, and may calculate a power transmission efficiency between the wireless power transmitter and the wireless power receiver based on the amount of output power and an amount of power received at the wireless power receiver. If the calculated power transmission efficiency is less than a predetermined value, the wireless power receiver may determine that the wireless power receiver incorrectly accesses the wireless power transmitter, may terminate an access to the wireless power transmitter, and may search for a new wireless power transmitter.

When the reset command is received, the wireless power receiver resets a wireless power reception system of the wireless power receiver. The resetting may include interrupting the communication function and control function and reactivating the communication function and control function, and/or searching for a new wireless power transmitter.

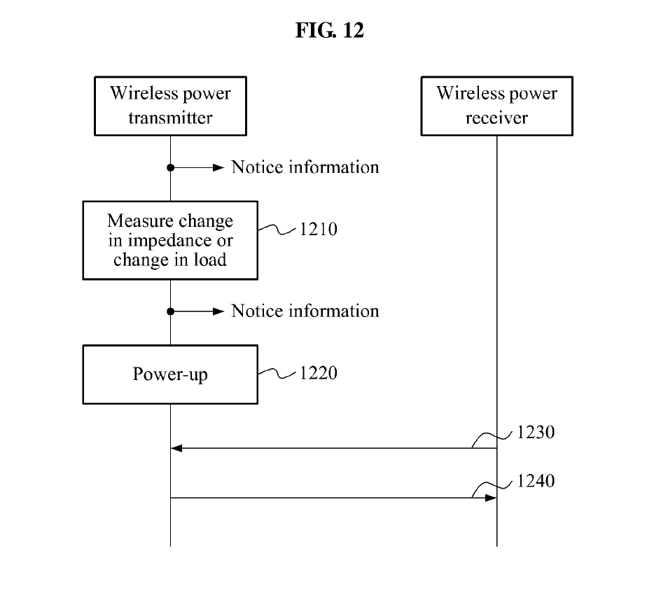

FIG. 12 is a flowchart illustrating an example of a method of detecting a device in a magnetic resonant wireless power transmission system. Referring to FIG. 12, a wireless power transmitter periodically transmits (e.g., broadcasts) notice information.

In operation 1210, a wireless power transmitter supplies detection power to a source resonator of the wireless power transmitter, and measures a change in an impedance of the source resonator, or a change in a load of the source resonator.

When the change in the impedance or the change in the load is measured to be greater than a predetermined value, in operation 1220, the wireless power transmitter supplies, to the source resonator, power greater than the detection power. For example, referring again to FIG. 10, when the detection power 1023 is supplied to the source resonator, and the change in the impedance or the change in the load is measured to be greater than the predetermined value, the wireless power transmitter supplies, to the source resonator, the detection power 1025 greater than the detection power 1023. In this example, the detection power 1025 is at the transmission power level B. Accordingly, the wireless power transmitter may flexibly control power based on circumstances.

Referring again to FIG. 12, when an amount of the power supplied from the wireless power transmitter to the source resonator is increased, the wireless power receiver may receive, from the wireless power transmitter, wake-up power needed to activate a communication function and a control function of the wireless power receiver. When the communication function and the control function are activated, in operation 1230, the wireless power receiver transmits a search signal to the wireless power transmitter. If a response signal corresponding to the search signal is not received, from the wireless power transmitter, within a predetermined period of time, the wireless power receiver may retransmit the search signal to the wireless power transmitter.

In operation 1240, the wireless power transmitter transmits, to the wireless power receiver, the response signal corresponding to the search signal. As described above in FIG. 11, the wireless power receiver may further transmit a request join signal to the wireless power transmitter.

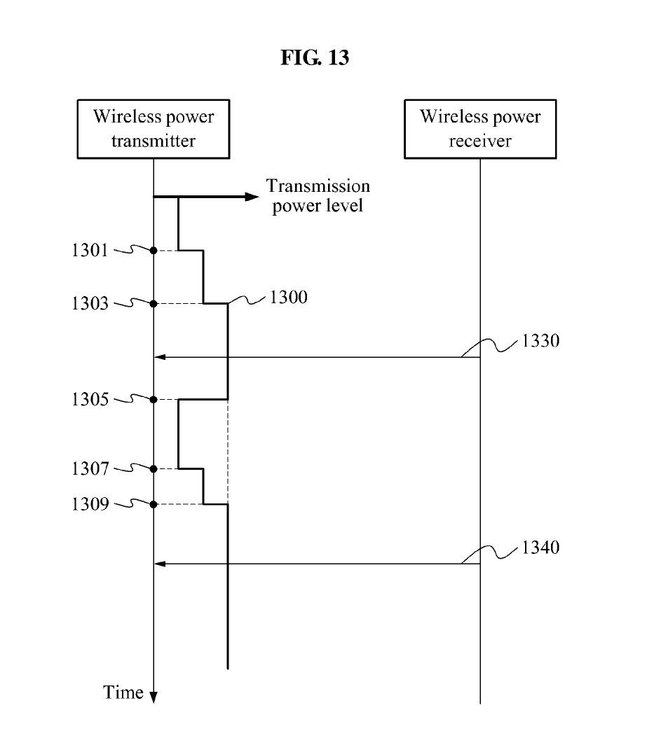

FIG. 13 is a flowchart illustrating an example of a method of controlling power in a magnetic resonant wireless power transmission system. Referring to FIG. 13, in operations 1301, 1303, 1305, 1307, and 1309 (or times 1301, 1303, 1305, 1307, and 1309), a wireless power transmitter may change a transmission power level 1300.

In each of operations 1330 and 1340, the wireless power transmitter receives, from a wireless power receiver, information on a change in power received at the wireless power receiver. The wireless power transmitter further determines whether the change in the received power is matched to a change in the transmission power level from operations 1301 and 1303 or operations 1307 and 1309, to determine whether the wireless power receiver incorrectly accesses the wireless power transmitter. For example, if the change in power received at operation 1330 does not match the change in the transmission power level from operations 1301 and 1303, the wireless power transmitter may determine that the wireless power receiver incorrectly accesses the wireless power transmitter. That is, the wireless power transmitter may determine whether the wireless power receiver incorrectly accesses the wireless power transmitter based on whether any change of the transmission power level between operations 1301, 1303, 1305, 1307, and 1309 is reflected on the respective change in the power received at the wireless power receiver in response to the operation 1301, 1303, 1305, 1307, or 1309.

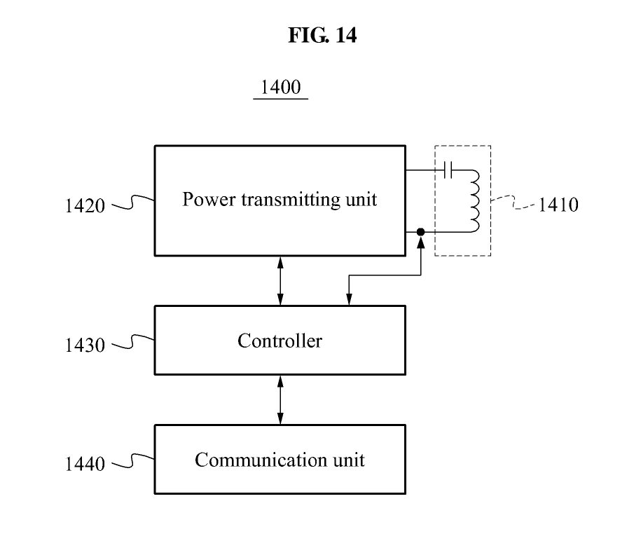

FIG. 14 is a diagram illustrating an example of a wireless power transmitter 1400. Referring to FIG. 14, the wireless power transmitter 1400 includes a source resonator 1410, a power transmitting unit 1420, a controller 1430, and a communication unit 1440.

The source resonator 1410 forms magnetic resonant coupling with a target resonator of a wireless power receiver.

The power transmitting unit 1420 generates power, and transmits the power to the wireless power receiver, using the magnetic resonant coupling.

The controller 1430 detects the wireless power receiver based on notice information transmitted from the wireless power transmitter 1400 to the wireless power receiver, and controls or allows the wireless power receiver to access the wireless power transmitter 1400, e.g., to receive the power from the wireless power transmitter 1400. The controller 1430 further determines whether the wireless power receiver incorrectly accesses the wireless power transmitter 1400 based on power control of the wireless power transmitter 1400 and/or a power transmission efficiency between the wireless power transmitter 1400 and the wireless power receiver.

When the wireless power receiver is determined to incorrectly access the wireless power transmitter 1400, the controller 1430 transmits a reset command to the wireless power receiver through the communication unit 1440. The communication unit 1440 may further periodically transmit the notice information to the wireless power receiver.

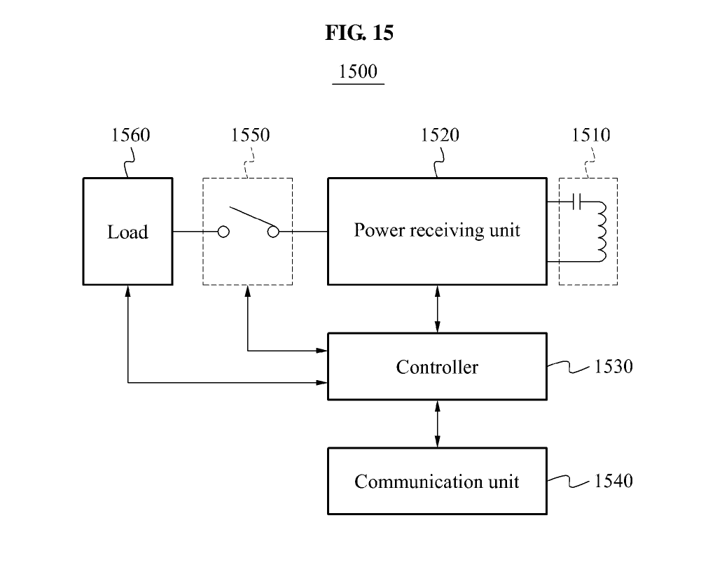

FIG. 15 is a diagram illustrating an example of a wireless power receiver 1500. Referring to FIG. 15, the wireless power receiver 1500 includes a target resonator 1510, a power receiving unit 1520, a controller 1530, a communication unit 1540, a switch unit 1550, and a load 1560.

The target resonator 1510 forms magnetic resonant coupling with a source resonator of a wireless power transmitter.

The power receiving unit 1520 receives power from the wireless power transmitter, using the magnetic resonant coupling. For example, the power receiving unit 1520 may include the matching network 121, the rectifier 122, the DC/DC converter 123, and the power detector 127 of FIG. 1.

The controller 1530 activates a communication function and a control function, using the received power (e.g., a wake-up power), and controls an access to the wireless power transmitter, e.g., to receive operation or charging power from the wireless power transmitter. The controller 1530 further receives a reset command from the wireless power transmitter through the communication unit 1540. When the reset command is received from the wireless power transmitter, the controller 1530 resets a system of the wireless power receiver 1500.

The communication unit 1540 performs communication with the wireless power transmitter. As discussed above, the communication unit 1540 receives the reset command from the wireless power transmitter.

The switch unit 1550 connects and disconnects the power receiving unit 1520 to and from the load 1560.

The load 1560 may include, for example, a battery.

The various units and methods described above may be implemented using one or more hardware components, one or more software components, or a combination of one or more hardware components and one or more software components.

A hardware component may be, for example, a physical device that physically performs one or more operations, but is not limited thereto. Examples of hardware components include microphones, amplifiers, low-pass filters, high-pass filters, band-pass filters, analog-to-digital converters, digital-to-analog converters, and processing devices.

A software component may be implemented, for example, by a processing device controlled by software or instructions to perform one or more operations, but is not limited thereto. A computer, controller, or other control device may cause the processing device to run the software or execute the instructions. One software component may be implemented by one processing device, or two or more software components may be implemented by one processing device, or one software component may be implemented by two or more processing devices, or two or more software components may be implemented by two or more processing devices.

A processing device may be implemented using one or more general-purpose or special-purpose computers, such as, for example, a processor, a controller and an arithmetic logic unit, a digital signal processor, a microcomputer, a field-programmable array, a programmable logic unit, a microprocessor, or any other device capable of running software or executing instructions. The processing device may run an operating system (OS), and may run one or more software applications that operate under the OS. The processing device may access, store, manipulate, process, and create data when running the software or executing the instructions. For simplicity, the singular term “processing device” may be used in the description, but one of ordinary skill in the art will appreciate that a processing device may include multiple processing elements and multiple types of processing elements. For example, a processing device may include one or more processors, or one or more processors and one or more controllers. In addition, different processing configurations are possible, such as parallel processors or multi-core processors.

A processing device configured to implement a software component to perform an operation A may include a processor programmed to run software or execute instructions to control the processor to perform operation A. In addition, a processing device configured to implement a software component to perform an operation A, an operation B, and an operation C may include various configurations, such as, for example, a processor configured to implement a software component to perform operations A, B, and C; a first processor configured to implement a software component to perform operation A, and a second processor configured to implement a software component to perform operations B and C; a first processor configured to implement a software component to perform operations A and B, and a second processor configured to implement a software component to perform operation C; a first processor configured to implement a software component to perform operation A, a second processor configured to implement a software component to perform operation B, and a third processor configured to implement a software component to perform operation C; a first processor configured to implement a software component to perform operations A, B, and C, and a second processor configured to implement a software component to perform operations A, B, and C, or any other configuration of one or more processors each implementing one or more of operations A, B, and C. Although these examples refer to three operations A, B, C, the number of operations that may implemented is not limited to three, but may be any number of operations required to achieve a desired result or perform a desired task.

Software or instructions that control a processing device to implement a software component may include a computer program, a piece of code, an instruction, or some combination thereof, that independently or collectively instructs or configures the processing device to perform one or more desired operations. The software or instructions may include machine code that may be directly executed by the processing device, such as machine code produced by a compiler, and/or higher-level code that may be executed by the processing device using an interpreter. The software or instructions and any associated data, data files, and data structures may be embodied permanently or temporarily in any type of machine, component, physical or virtual equipment, computer storage medium or device, or a propagated signal wave capable of providing instructions or data to or being interpreted by the processing device. The software or instructions and any associated data, data files, and data structures also may be distributed over network-coupled computer systems so that the software or instructions and any associated data, data files, and data structures are stored and executed in a distributed fashion.

For example, the software or instructions and any associated data, data files, and data structures may be recorded, stored, or fixed in one or more non-transitory computer-readable storage media. A non-transitory computer-readable storage medium may be any data storage device that is capable of storing the software or instructions and any associated data, data files, and data structures so that they can be read by a computer system or processing device. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, or any other non-transitory computer-readable storage medium known to one of ordinary skill in the art.

Functional programs, codes, and code segments that implement the examples disclosed herein can be easily constructed by a programmer skilled in the art to which the examples pertain based on the drawings and their corresponding descriptions as provided herein.

As a non-exhaustive illustration only, a device described herein may be a mobile device, such as a cellular phone, a personal digital assistant (PDA), a digital camera, a portable game console, an MP3 player, a portable/personal multimedia player (PMP), a handheld e-book, a portable laptop PC, a global positioning system (GPS) navigation device, a tablet, a sensor, or a stationary device, such as a desktop PC, a high-definition television (HDTV), a DVD player, a Blue-ray player, a set-top box, a home appliance, or any other device known to one of ordinary skill in the art that is capable of wireless communication and/or network communication.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method for communication and power control of a wireless power transmitter, the method comprising:
transmitting notice information to a wireless power receiver;
detecting a wireless power receiver based on the notice information, the wireless power receiver accessing the wireless power transmitter;
determining whether the wireless power receiver is to cease the accessing of the wireless power transmitter based on a power control and/or a power transmission efficiency; and
transmitting a reset command to the wireless power receiver in response to the wireless power receiver being determined to incorrectly access the wireless power transmitter.

2. The method of claim 1, wherein the detecting comprises:
transmitting, to the wireless power receiver, a wake-up power to be used to activate a communication function of the wireless power receiver;
receiving, from the wireless power receiver, a search signal corresponding to the notice information; and
transmitting, to the wireless power receiver, a response signal corresponding to the search signal.

3. The method of claim 1, wherein the detecting comprises:
supplying a detection power to a source resonator of the wireless power transmitter;
measuring a change in an impedance of the source resonator, or a change in a load of the source resonator;
supplying, to the source resonator, a power greater than the detection power in response to the change in the impedance, or the change in the load, being measured to be greater than a predetermined value; and
receiving, from the wireless power receiver, a search signal corresponding to the notice information; and
transmitting, to the wireless power receiver, a response signal corresponding to the search signal.

4. The method of claim 1, wherein:
the notice information comprises a network identifier (ID) of the wireless power transmitter; and
the detecting comprises comparing a network ID received from the wireless power receiver with the network ID included in the notice information.

5. The method of claim 1, wherein the determining comprises:
changing a power supplied to a source resonator of the wireless power transmitter based on a predetermined timing;
receiving, from the wireless power receiver, information on a change in a power received at the wireless power receiver; and
determining whether the change in the received power is matched to the change in the supplied power.

6. The method of claim 1, wherein the determining comprises:
generating an operation power to be used to operate the wireless power receiver;
transmitting the operation power to the wireless power receiver;
receiving, from the wireless power receiver, information on an amount of a power received at the wireless power receiver;
comparing an amount of the operation power with the amount of the received power; and
determining whether the wireless power receiver is to cease the accessing of the wireless power transmitter based on the comparison.

7. The method of claim 1, wherein the determining comprises:
transmitting, to the wireless power receiver, information on an amount of a power transmitted by the wireless power transmitter;
receiving, from the wireless power receiver, information on the power transmission efficiency between the wireless power transmitter and the wireless power receiver;
comparing the received power transmission efficiency with a power transmission efficiency allowed between the wireless power transmitted and the wireless power receiver; and
determining whether the wireless power receiver is to cease the accessing of the wireless power transmitter based on the comparison.

8. The method of claim 1, wherein the determining comprises:
generating an operation power to be used to operate the wireless power receiver;
transmitting the operation power to the wireless power receiver;
receiving, from the wireless power receiver, information on an amount of a power received at the wireless power receiver;
calculating the power transmission efficiency between the wireless power transmitter and the wireless power receiver based on the amount of the received power;
comparing the calculated power transmission efficiency with a power transmission efficiency allowed between the wireless power transmitter and the wireless power receiver; and
determining whether the wireless power receiver is to cease the accessing of the wireless power transmitter based on the comparison.

9. The method of claim 1, wherein the determining comprises:
receiving, from the wireless power receiver, a received signal strength indication (RSSI) of a signal transmitted by the wireless power transmitter to the wireless power receiver;
comparing the RSSI with a predetermined value; and
determining whether the wireless power receiver is to cease the accessing of the wireless power transmitter based on the comparison.

10. A method for communication and power control of a wireless power receiver, the method comprising:
receiving notice information from a wireless power transmitter;
transmitting a search signal to the wireless power transmitter based on the notice information;
accessing the wireless power transmitter based on the search signal; and
resetting the wireless power receiver in response to a reset command being received from the wireless power transmitter.

11. The method of claim 10, further comprising:
searching for a new wireless power transmitter in response to the wireless power receiving being reset.

12. The method of claim 10, wherein the accessing comprises:
receiving a wake-up power from the wireless power transmitter;
activating a communication function, using the wake-up power; and
receiving, from the wireless power transmitter, a response signal corresponding to the search signal.

13. The method of claim 10, wherein:
the notice information comprises a network identifier (ID) of the wireless power transmitter; and
the search signal comprises the network ID.

14. The method of claim 10, further comprising, prior to receiving the reset command:
measuring a received signal strength indication (RSSI) of a signal received from the wireless power transmitter; and
transmitting the RSSI to the wireless power transmitter.

15. The method of claim 10, further comprising, prior to receiving the reset command:
measuring a change in a power received from the wireless power transmitter; and
transmitting, to the wireless power transmitter, information on the change in the received power.

16. The method of claim 15, wherein:
the change in the received power comprises a change in a current and/or a change in a voltage; and
the change in the received power is measured between a target resonator and a rectification unit of the wireless power receiver, or at an output end of the rectification unit, or at an input end of a battery of the wireless power receiver, or any combination thereof.

17. The method of claim 10, further comprising, prior to receiving the reset command:
receiving an operation power from the wireless power transmitter; and
transmitting, to the wireless power transmitter, information on an amount of the received operation power.

18. The method of claim 17, wherein:
the amount of the received operation power comprises an amount of a current; and
the amount of the current is measured between a target resonator and a rectification unit of the wireless power receiver, or at an output end of the rectification unit, or at an input end of a battery of the wireless power receiver, or any combination thereof.

19. The method of claim 10, further comprising, prior to receiving the reset command:
receiving, from the wireless power transmitter, information on an amount of a power transmitted by the wireless power transmitter;
calculating a power transmission efficiency based on the amount of the transmitted power; and
transmitting, to the wireless power transmitter, information on the power transmission efficiency.

20. A wireless power transmitter comprising:
a communication unit configured to transmit notice information to a wireless power receiver; and
a controller configured to
detect the wireless power receiver based on the notice information, the wireless power receiver accessing the wireless power transmitter, and
determine whether the wireless power receiver is to cease the accessing of the wireless power transmitter based on a power control and/or a power transmission efficiency,
wherein the communication unit is further configured to transmit a reset command to the wireless power receiver in response to the wireless power receiver being determined to incorrectly access the wireless power transmitter.

21. A wireless power receiver comprising:
a communication unit configured to
receive notice information from a wireless power transmitter, and
transmit a search signal to the wireless power transmitter based on the notice information; and
a controller configured to
access the wireless power transmitter based on the search signal, and
reset the wireless power receiver in response to a reset command being received from the wireless power transmitter.
